(19) United States
(12) Patent Application Publication
(10) Pub. No.: US 2022/0053732 A1
(43) Pub. Date: Feb. 24, 2022

(54) CAGE FOR TRANSPORTING PETS

(71) Applicants: Giovanni Lorenzo Daniele BASSI, Rivera-Monteceneri (CH); Giovanni Mijo Giacomo BASSI, Rivera-Monteceneri (CH)

(72) Inventor: Giovanni Mijo Giacomo BASSI, Rivera-Monteceneri (CH)

(21) Appl. No.: 17/414,060

(22) PCT Filed: Nov. 29, 2019
(86) PCT No.: PCT/IB2019/060322

§ 371 Date: Jun. 15, 2021

(30) Foreign Application Priority Data
Dec. 17, 2018 (CH) 01553/18

(51) Int. Cl. A01K 1/02

(52) U.S. Cl. CPC A01K 1/0272; A01K 1/0245

(57) ABSTRACT

Cage (1) for transporting pets, such as dogs or cats, on mobile vehicles of the type comprising: —at least one front wall (2), at least one back wall (3); at least two opposite side walls (4) and at least one bottom wall (5), characterized by comprising at least one passive safety system (10) comprising: —at least one inflatable element (13); —at least one capsule connected to said inflatable element (13); —said capsule containing at least one explosive substance; said capsule being configured to make the explosive substance explode such as to emit gas adapted to inflate said inflatable element; —at least one detonator configured to trigger the explosive substance contained in said explosive capsule; —at least one sensor configured to detect a deceleration of said cage and to send a signal; —at least one electronic control unit configured to receive a signal from said sensor, to process it and to send an igniting command to said detonator.

### FIELD OF THE INVENTION

The present invention concerns the field of animal transport safety and, in particular, a cage for transporting pets, such as dogs and cats, in motorized vehicles.

### KNOWN ART

As a rule, small cages or kennels of appropriate sizes and shaped to house the animal during transport are provided to transport dogs and cats in cars.

The Applicant has observed that the cages, kennels or carriages currently available are generally provided to prevent suitcases from falling on animals since both are often transported in the trunk of the vehicle.

Moreover, the known cages, kennels or carriages are provided so that to increase cleanliness inside the passenger compartment of the vehicle, thus avoiding the dispersion of hair, drool or any physiological need or vomit of the transported animal.

Moreover, the Applicant has observed that the known cages, carriages or kennels essentially have the function of preventing the animal from being able to disturb the driver of the vehicle while driving, and to simultaneously try to offer the greatest space or comfort to the transported animal.

Finally, the Applicant has observed that the cages, kennels or carriages currently available on the market aim to improve the safety of people inside the vehicle's passenger compartment in the event of an accident, but not that of the transported animal. Only a few known devices however tend to reduce the negative and often lethal consequences that a collision or other form of accident could have for pets that are in cages, inside the motor vehicles. As shown by a test published by the Swiss TCS, in February 2018, concerning the transport of dogs in cars (a test which includes the data already collected in another and previous TCS test of 2013), development in this sector has achieved little progress over the years, and almost never in the direction of also improving the safety of transported animals.

The Applicant has thus found the need to provide a new type of cage for transporting pets, such as dogs and cats, in motorized vehicles and which solves the issues of known cages, carriages or kennels.

In particular, the Applicant intends to provide a cage for transporting pets which can protect the animal transported therein in case of an accident.

### SUMMARY OF THE INVENTION

Thus, in its first aspect, the invention concerns a cage for transporting pets, such as dogs or cats, on mobile vehicles of the type comprising:
at least one front wall, at least one back wall; at least two opposite side walls and at least one bottom wall, characterized by comprising at least one passive safety system comprising:
at least one inflatable element;
at least one capsule connected to said inflatable element; said capsule containing at least one explosive substance; said capsule being configured to make the explosive substance explode such as to emit gas adapted to inflate said inflatable element;
at least one detonator configured to trigger the explosive substance contained in said explosive capsule;
at least one sensor configured to detect a deceleration of said cage and to send a signal;
at least one electronic control unit configured to receive a signal from said sensor, to process it and to send an igniting command to said detonator.

In the aforesaid aspect, the present invention can have at least one of the preferred characteristics defined hereunder.

Advantageously, the cage comprises at least two passive safety systems; each passive safety system being positioned at a side wall so that to withhold the transported animal in-between them whenever the passive safety systems are activated.

Preferably, the cage comprises at least one passive safety system arranged at the back wall of the cage.

Conveniently, the cage comprises at least one base shaped to try to withhold the transported animal inside the cage substantially parallel to the side walls, with the face facing the front wall.

Advantageously, the base element comprises at least one cavity for at least partially accommodating the animal, the cavity having two side walls and one back wall; said side walls having, in cross section, an inclination with respect to an axis of longitudinal extent of the cage.

Preferably, the cavity is, in a section parallel to the bottom wall, “U-shaped” with the legs of the “U” facing the front wall.

Conveniently, the side walls of the cage are arranged inclined so that to decrease the inner width of the cage, running upwards from the bottom wall.

Advantageously, the cage has an inner height selected depending on the height at the withers of the animal to be transported, so that the inner height is at the most equal to 1.3 times the height at the withers of the animal to be transported.

Conveniently, the cage has a maximum inner width selected according to the width at the chest of the animal to be transported, so that the maximum inner width is at the most equal to 2.5 times the width at the chest of the animal to be transported.

Preferably, said at least one sensor configured to detect a deceleration of said cage and to send a signal comprises at least one accelerometer.

Conveniently, the cage can further have at least one presence sensor arranged at a portion of the base element; said at least one presence sensor being configured to detect the presence of the transported animal resting at the portion of the base element and to send a signal to the control unit, so that to inhibit the inflating of the inflatable element, whenever said presence sensor detects the presence of the transported animal resting at the portion of the base element.

Conveniently, the capsule is a multistage capsule able to vary the inflating speed of the inflatable element.

Further characteristics and advantages of the invention will become clearer in the detailed description of some preferred, but not exclusive, embodiments of a cage for transporting pets, such as dogs or cats, according to the present invention.

### BRIEF DESCRIPTION OF THE DRAWINGS

Such description will be exposed hereunder with reference to the accompanying drawings, only provided by way of example and thus not limiting, in which:

FIG. 1 shows a schematic side view of a cage for transporting pets, such as dogs or cats, according to the present invention, with the passive safety devices closed;

FIG. 2 shows a schematic side view of a cage for transporting pets, such as dogs or cats, according to the present invention, with the passive safety devices open;

FIG. 3 shows a schematic side view of a cage for transporting pets, such as dogs or cats, according to the present invention, with the passive safety devices open; and

FIG. 4 shows an enlarged perspective view of the base element of the cage according to the present invention.

### DETAILED DESCRIPTION OF EMBODIMENTS OF THE INVENTION

With reference to the figures, a cage for transporting pets, such as dogs or cats, on mobile vehicles such as cars, small vans, trucks according to the present invention is shown with the numerical reference 1.

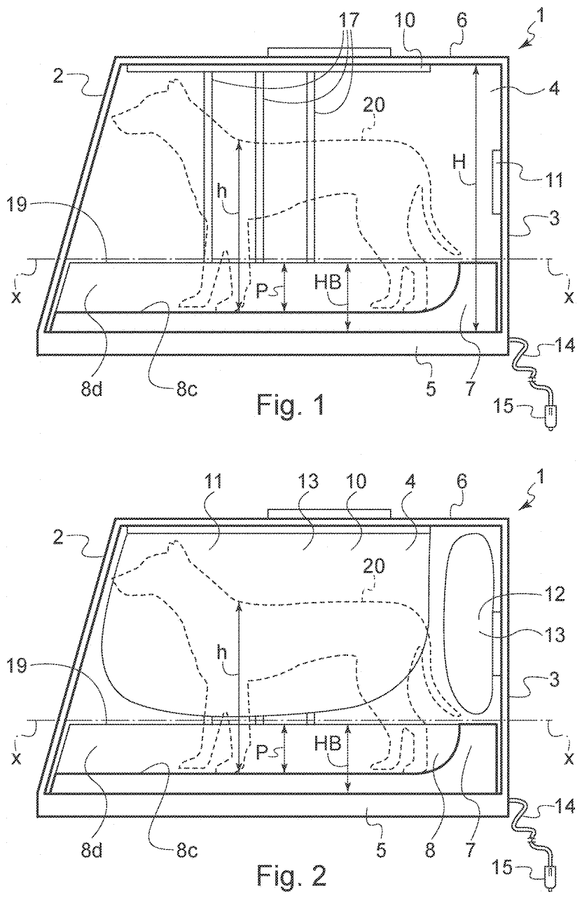

In the preferred embodiment shown in the FIG. 1, the cage 1 for transporting pets, such as dogs or cats, comprises a front wall 2, a back wall 3, two opposite side walls 4 with respect to a direction of longitudinal extent X-X, an upper wall 6 and at least one bottom wall 5.

The front wall 2 generally comprises the access opening, closed by an appropriate small door that can be opened, not shown in the figure, however, the access opening, as well as the respective small door, could be positioned on another wall, for example a side wall 4, without departing from the protection scope of the present invention.

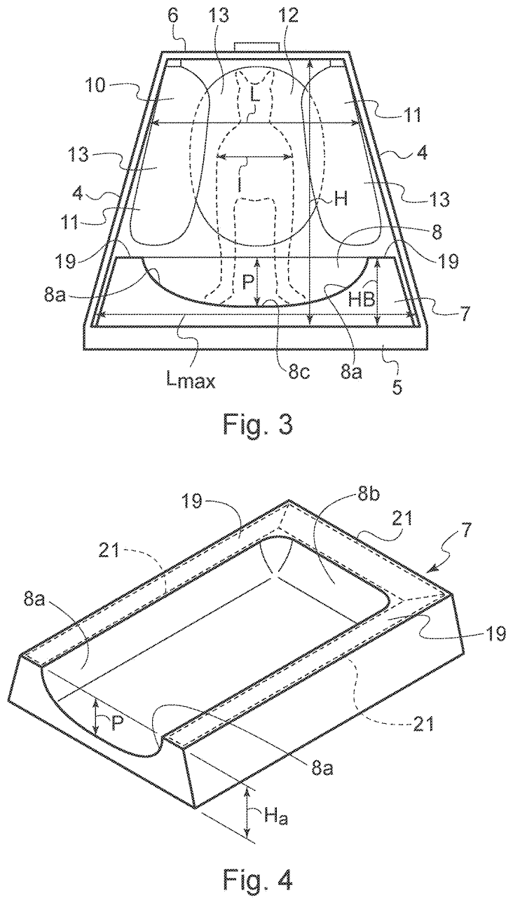

Preferably, the side walls 4, as better shown in FIG. 3, are inclined so that to decrease the inner width L of the cage 1, when away from the bottom wall 5 in a vertical direction, i.e. towards the upper wall 6.

In the embodiment shown in the figures, the side walls 4 can be made with regularly spaced hollow tubular metal elements 17. The inner height H of the cage 1, measured from the inner surface of the bottom wall to the inner wall of the upper wall 6, is such as to lead the transported animal 20 to withhold a seated position or with the abdomen completely on the ground.

The inner measures, in particular the height H and width L, of the cage 1 are thus such as to ensure a reasonable comfort of the transported animal 20, but limitedly, such as to lead the transported animal 20 to withhold an adequate position in case of braking and/or an accident.

The inner measures of the cage 1 are such as to lend limited comfort in height, width and depth to the transported animal 20, but such as not to hinder the entry and getting out of the transported animal 20 in the cage 1. The choice of limited inner measures, although not allowing the transported animal 20 to move freely, however ensures, in case of shock, that its mass does not suffer an excessive acceleration followed by a violent, too violent deceleration. This occurs in the most devastating way the greater the theoretical movement space of the transported animal is.

In fact, according to the Applicant, the inner measures of the cage 1 must be well proportioned to the size of the transported animal 20.

For large lots, reference is made to the measures of the transported animal's size.

The cage 1 for transporting pets thus has an inner height H selected depending on the height at the withers of the animal to be transported h, so that the inner height H is at the most equal to 1.3 times the height at the withers h of the animal to be transported 20.

Preferably, the cage 1 has an inner height at the most equal to 1.25 times the height at the withers h of the animal to be transported 20.

The cage 1 for transporting pets further has a maximum inner width L selected depending on the width 1 at the chest of the animal 20 to be transported, so that the maximum inner width L is at the most equal to 2.5 times the width 1 at the chest of the animal to be transported 20.

Preferably, the cage 1 has a maximum inner width Lmax at the most equal to 2.4 times the width 1 at the chest of the animal to be transported 20.

Always for withholding the animal to be transported in a well-defined position during the transport, the cage has at least one base element.

In the embodiment shown in the figures, the base element 7 is removable with respect to the cage 1 so that to allow its cleaning or replacement in case of deterioration.

The base element 7 is shaped to withhold the transported animal 20 inside the cage 1 substantially parallel to the side walls 4, with the snout facing the front wall 2, which is generally positioned opposite the forward travel direction of the vehicle.

The base element 7 is shaped to abut against the bottom wall 5 and to at least partially accommodate the animal to be transported 20.

To this end, the base element 7 comprises at least one cavity 8 for accommodating, at least partially, the animal to be transported 20.

The cavity 8 has two side walls 8a and one back wall 8b.

In the embodiment shown in the figures, the side walls 8a and the side wall 8b are joined to form a single wall.

The side walls 8a have, in cross section, an inclination with respect to a longitudinal extent axis X-X of the cage 1.

In the embodiment shown in the figures, the side walls 8a of the cavity follow a curvilinear profile intended to reduce the inclination with the longitudinal axis X-X of the cage 1 when approaching the bottom portion 8c of the cavity 8. The bottom portion 8c shown is an area of longitudinal extent at the maximum depth P of the cavity 8.

The maximum depth P of the cavity 8 is between 70% and 97% of the maximum outer height HB of the base element 7.

In the embodiment shown in the figures, the side walls 8a of the cavity 8 are arranged according to a curvilinear profile joined to the bottom portion 8c of the cavity 8.

The cavity 8 is, in a section parallel to the bottom wall 5, “U-shaped” with the legs of the “U” facing said front wall 2 of the cage 1.

The base element 7 is preferably made of plastic. Preferably, the plastic of the base element 7 is selected so that to be able to have scratch-resistant surfaces that can be washed with water.

Preferably, the maximum outer height HB of the base element 7 is selected so that to be between 20% and 30% of the inner height H of the cage 1.

Preferably, the maximum outer height HB of the base element 7 is selected so that to be between 22% and 27% of the inner height H of the cage 1.

According to an important aspect of the present invention, the cage 1 has at least one passive safety system 10.

In the embodiment shown in the figures, there are at least three passive safety systems 10, but there could be more or less, at least one, without departing from the protection scope of the present invention.

In particular, in the embodiment shown in FIG. 3, there are two lateral passive safety systems 11 and a rear one 12.

Each passive safety element 10 comprises at least one inflatable element 13 and at least one capsule connected to the inflatable element 13.

In the embodiment shown in the figures, each passive system element 10 comprises at least one inflatable element 13 and one capsule connected to the inflatable element 13.

The capsule contains at least one explosive substance. The capsule is configured to make the explosive substance explode so that to emit a gas, typically sodium azide, contained in quantities from 50 to 200 g and adapted to inflate the inflatable element 13.

The capsule is functionally connected to at least n detonators configured to trigger the explosive substance contained in the explosive capsule.

Each capsule can be of the multistage type, i.e. of three or more intensities. Different intensities vary the inflating speed of the inflatable element 13.

Each passive safety element 10 further comprises at least one sensor configured to detect a deceleration of the cage and to send a signal to a control unit.

Preferably, the sensor comprises at least one accelerometer which, depending on the deceleration direction, sends a signal to a control unit.

The passive safety system further comprises an electronic control unit configured to receive a signal from the sensor, to process it and to send an igniting command to the detonator in order to detonate the capsule and to inflate the inflatable element 13.

The control unit, depending on the data received from the accelerometer of each passive safety element 10, selectively determines which passive safety device to actuate.

In other words, the control unit could decide to activate the rear safety device 12 and/or one of the lateral ones 11 or all three devices.

The base element 7 can further comprise at least one presence sensor 21 arranged at a portion thereof, preferably upper.

The presence sensor 21 is configured to detect the presence of the transported animal resting at the portion of the base element 7, at which it is placed, and to consequently send a signal to the control unit so that to inhibit the inflating of the inflatable element 13, whenever the presence sensor 21 detects the presence of the transported animal resting at such portion of the base element 7.

In other words, the control unit inhibits the inflating of the inflatable element 13 closest to the portion of the base element 7, at which the presence sensor 21 that detected the animal resting is positioned.

In the embodiment shown in the figures, the control unit inhibits the inflating of the inflatable element 13 by rejecting the ignition of the respective detonator.

Preferably, in the embodiment shown in the figures, there are three position sensors 21, two positioned in the base element 7 at the side walls 8a and one in the proximity of the back wall 8b.

The lateral passive safety devices 11 are arranged at the upper portion of the side walls 4, so that the inflatable elements 13 do not touch each other when they come out and, in their lower part and into contact with the upper surface 19 of the base element 7, without invading the vertical projections of the side walls 8a and that of the bottom portion 8c of the cavity 8.

This will prevent that transported animal 20, which could unfortunately not be in the desired position as a result of the sizes of the cage and of the bottom element 7, from suffering damages, thus injuries caused by the explosion of the inflatable elements 13.

The rear passive safety device 12 can be installed inside the cage 1 and “outwardly” from the back wall 3 or incorporated therein. In this case, the inflatable element 13 can be oval-shaped in vertical section.

The lateral passive safety devices 11 can also be installed inside the cage 1 and “outwardly” from the side walls 4, preferably at the two edges formed in-between the side walls 4 and the upper wall 6. Alternatively, the lateral passive safety devices 11 can be incorporated in the side walls 4.

In this case, the inflatable elements 13 can be of the drop down curtain/“windowbag” type or of rectangular shape in vertical section.

The passive safety systems 10 are directly supplied by the power provided by the vehicle's 12 v socket present in the trunk or in other parts of the vehicle's passenger compartment and, for this purpose, the cage 1 can have an appropriate supply cable 14, a socket 15 and possibly a transformer.

Alternatively or in combination, the cage 1 can have at least one pack of batteries, preferably rechargeable. Finally, each passive safety device can have, at a visible portion thereof, two LEDs connected to the control unit: one showing the operation of the passive safety device itself and a second signaling possible defects thereof.

The passive safety devices 10 can be of pyrotechnics type or of hybrid type, in the latter case, a second capsule, containing precompressed inert gas to inflate the inflatable element 13, is typically present.

Different changes can be made to the embodiments described in detail, anyhow remaining within the protection scope of the invention, defined by the following claims.

1. Cage for transporting pets, such as dogs or cats, on mobile vehicles of the type comprising:
at least one front wall, at least one back wall; at least two opposite side walls and at least one bottom wall, comprising at least one passive safety system comprising:
at least one inflatable element;
at least one capsule connected to said inflatable element;
said capsule containing at least one explosive substance; said capsule being configured to make the explosive substance explode such as to emit gas adapted to inflate said inflatable element;
at least one detonator configured to trigger the explosive substance contained in said explosive capsule;
at least one sensor configured to detect a deceleration of said cage and to send a signal;
at least one electronic control unit configured to receive a signal from said sensor, to process it and to send an igniting command to said detonator.

2. Cage for transporting pets according to claim 1, comprising at least two passive safety systems; each passive safety system being positioned at one said side wall so that to withhold the transported animal in-between them whenever the passive safety systems are activated.

3. Cage for transporting pets according to claim 1, comprising at least one passive safety system arranged at the back wall of said cage (1).

4. Cage for transporting pets according to claim 1, comprising at least one base shaped to withhold the transported animal inside the cage substantially parallel to said side walls, with the snout facing said front wall.

5. Cage for transporting pets according to claim 4, wherein said base element comprises at least one cavity for accommodating, at least partially, the animal to be transported, said cavity having two side walls and one back wall; said side walls having, in cross section, an inclination with respect to a longitudinal extent axis (X-X) of the cage.

6. Cage for transporting pets according to claim 4, wherein said cavity is, in a section parallel to said bottom wall, “U-shaped” with the legs of the “U” facing said front wall.

7. Cage for transporting pets according to claim 4, wherein at least said side walls are arranged inclined so that to decrease the inner width (L) of the cage running upwards from the bottom wall.

8. Cage for transporting pets according to claim 1, having an inner height (H) selected depending on the height at the withers of the animal to be transported (h), so that the inner height (H) is at the most equal to 1.3 times the height at the withers (h) of the animal to be transported (20).

9. Cage for transporting pets according to claim 1, having a maximum inner width (Lmax) selected depending on the width at the chest (l) of the animal to be transported, so that the maximum inner width (Lmax) is at the most equal to 2.5 times the width at the chest (l) of the animal to be transported.

10. Cage for transporting pets according to claim 1, wherein said at least one sensor configured to detect a deceleration of said cage and to send a signal comprises at least one accelerometer.

11. Cage for transporting pets according to claim 5, comprising at least one presence sensor arranged at a portion of said base element; said at least one presence sensor being configured to detect the presence of the transported animal resting at said portion of said base element and to send a signal to said control unit to inhibit the inflating of the inflatable element, whenever said presence sensor detects the presence of the transported animal resting at the portion of said base element.

12. Cage for transporting pets according to claim 1, wherein said capsule is a multistage capsule able to vary the inflating speed of the inflatable element.
